(19) United States
(12) Patent Application Publication
(10) Pub. No.: US 2023/0385860 A1
(43) Pub. Date: Nov. 30, 2023

(54) Computing System for Analyzing Consumer Intentions

(71) Applicant: Meshplus Co., Ltd., Taipei (TW)

(72) Inventors: Kuang-Jui Hu, Taipei (TW); Ying-Hsueh Tseng, Taipei (TW); Po-Hsun Wang, Taipei (TW)

(73) Assignee: Meshplus Co., Ltd., Taipei (TW)

(21) Appl. No.: 18/145,372

(22) Filed: Dec. 22, 2022

(30) Foreign Application Priority Data
May 26, 2022 (TW) 111119611

(51) Int. Cl. G06Q 30/0204

(52) U.S. Cl. CPC G06Q 30/0204

(57) ABSTRACT

The invention discloses a computing system for analyzing consumer intentions comprising a user data processing module, an offline-point-and-website-visiting computing module and a cross-websites-visiting computing module. The user data processing module sorts a website visiting data cluster and an offline point visiting data cluster from raw data. The offline-point-and-website-visiting computing module is connected to the user data processing module, obtains an offline-point-and-website-dual-visiting data cluster, and derives offline-point-and-website-visiting overlapping proportion information of a business store. The cross-websites-visiting computing module is connected to the user data processing module to sort single-website-visiting data clusters relating to their respective target websites designated and obtains cross-websites-visiting overlapping proportion information.

### FIELD OF THE INVENTION

The present invention relates to a computing system, and more particularly relates to a computing system for analyzing consumer intentions.

### BACKGROUND OF THE INVENTION

At present, surveys on the consumers' preferences or purchase intentions are mostly obtained through filling out survey questionnaires by consumers. In the survey questionnaires, a series of questions about the surveyors' products and information as a list may be directly listed for a responder to answer one by one. In other words, the responders may be deliberately guided by the survey questionnaires and unconsciously give the answers expected in advance by the surveyor. Even if the questions given to the responder are neither “true or false questions” nor “multiple choice questions” but are “essay questions”, the answers of the responder are still strongly implied and guided by the survey questionnaires.

Therefore, the results obtained by the conventional surveys on consumers' purchase intentions merely reflect a prejudice which is guided and implied by the surveyor such that objective and unbiased consumer survey results cannot be obtained. In addition, the answers from the responder may also be affected by the environmental conditions (e.g., on the busy street or in a quiet room with air conditioning) and show great contrasts such that an accuracy of the answer level is difficult to obtain.

### SUMMARY OF THE INVENTION

Therefore, one objective of the present invention is to provide a computing system for analyzing consumer intentions which can accurately predict the consumer intentions by the consumers' behavior analysis, thereby facilitating the subsequent planning in advertising and marketing.

In order to overcome the technical problems in prior art, the present invention provides a computing system for analyzing consumer intentions, comprising: a user data processing module having a data obtaining unit and a data statistical unit, the data obtaining unit obtaining raw data from a database, the raw data containing a plurality of user data, each of which being corresponding to a consumer and containing a website visiting history and/or an offline point visiting history, wherein the website visiting history is a visiting history of online websites on which the consumer has visited, the offline point visiting history is a visiting history of offline points on which the consumer has visited, the data statistical unit sorts, from the plurality of user data, a website visiting data cluster and an offline point visiting data cluster, the website visiting data cluster is a cluster of the user data containing the website visiting history, the offline point visiting data cluster is a cluster of the user data containing the offline point visiting history; an offline-point-and-website-visiting computing module being connected to the user data processing module, wherein the offline-point-and-website-visiting computing module obtains, according to the website visiting data cluster and the offline point visiting data cluster, an offline-point-and-website-dual-visiting data cluster, the offline-point-and-website-dual-visiting data cluster is a cluster of the user data containing both the website visiting history of any online website of a business store and the offline point visiting history of any offline-point of the business store, and the offline-point-and-web site-visiting computing module derives, according to an overlapping proportion of the consumers corresponding to the offline-point-and-website-dual-visiting data cluster to the consumers corresponding to the web site visiting data cluster, offline-point-and-website-visiting overlapping proportion information of the business store which is served as an online-to-offline overlapping analysis index; and a cross-websites-visiting computing module being connected to the user data processing module, wherein the cross-websites-visiting computing module sorts, according to the website visiting data cluster, single-website-visiting data clusters relating to their respective target websites, each of the single-website-visiting data clusters is a single-target-website user data cluster containing the website visiting history of the target website, and the cross-websites-visiting computing module further derives a cross-websites-visiting user amount of the consumers corresponding to the designated single-website-visiting data cluster who have also visited any other target website and derives a single-website-visiting user amount of the consumers corresponding to the designated single-website-visiting data cluster so that cross-websites-visiting overlapping proportion information is obtained according to a proportion of the cross-websites-visiting user amount to the single-website-visiting user amount and is served as a cross-websites overlapping analysis index.

In one embodiment of the present invention, a computing system for analyzing consumer intentions is provided, wherein the user data processing module further has a time period setting unit connected to the data statistical unit, the time period setting unit is provided to set a data sorting time period, and according to the data sorting time period, the data statistical unit respectively sorts the website visiting data cluster of the website visiting history in the data sorting time period and the offline point visiting data cluster of the offline point visiting history in the data sorting time period.

In one embodiment of the present invention, a computing system for analyzing consumer intentions is provided, wherein the computing system for analyzing consumer intentions further comprising a active-browsing-website computing module connected to the user data processing module, wherein the active-browsing-website computing module derives, according to the website visiting data cluster, rankings of visiting footprint amounts relating to respective comparison websites to obtain website popularity information which is served as a popular website footprint analysis index, wherein the visiting footprint amount is a total number of the consumers corresponding to the user data of the website visiting history relating to the comparison website.

In one embodiment of the present invention, a computing system for analyzing consumer intentions is provided, wherein the user data processing module is connected to the database so that the data obtaining unit obtains the raw data from the database, and a real identity feature of the consumer is performed a de-identification process to obtain an individual identification code corresponding to the user data in the database.

In one embodiment of the present invention, a computing system for analyzing consumer intentions is provided, wherein the user data processing module contains a website visiting data pre-processing unit, the website visiting data pre-processing unit derives, according to a domain name format, the website visiting history of the user data from the raw data.

In one embodiment of the present invention, a computing system for analyzing consumer intentions is provided, wherein the user data processing module contains an offline point visiting data pre-processing unit, the offline point visiting data pre-processing unit derives, according to a default address format, the offline point visiting history of the user data from the raw data, the default address format contains Arabic numerals, commas and decimal point.

In one embodiment of the present invention, a computing system for analyzing consumer intentions is provided, wherein the offline point visiting history of the user data contains longitude and latitude data of the offline point which the consumer has visited.

The computing system for analyzing consumer intentions of the present invention has the technical effects as follows. The consumers' preferences or purchase intentions can be accurately predicted so as to facilitate the subsequent planning in advertising and marketing.

### BRIEF DESCRIPTION OF THE DRAWINGS

FIG. 1 is a schematic block diagram illustrating a computing system for analyzing consumer intentions according to one embodiment of the present invention;

FIG. 2 is a schematic diagram illustrating raw data of the computing system for analyzing consumer intentions according to the embodiment of the present invention;

FIG. 3 is a schematic diagram illustrating a process of obtaining an offline-point-and-website-dual-visiting data cluster from the raw data by the computing system for analyzing consumer intentions according to the embodiment of the present invention;

FIG. 4 is a schematic diagram illustrating a process of obtaining a website visiting data cluster and an offline point visiting data cluster from the raw data by a user data processing module of the computing system for analyzing consumer intentions according to one embodiment of the present invention; and

FIG. 5 is a schematic diagram illustrating a process of obtaining cross-websites-visiting overlapping proportion information from a single-website-visiting data cluster by a cross-websites-visiting computing module of the computing system for analyzing consumer intentions according to the embodiment of the present invention.

### DETAILED DESCRIPTION OF THE PREFERRED EMBODIMENTS

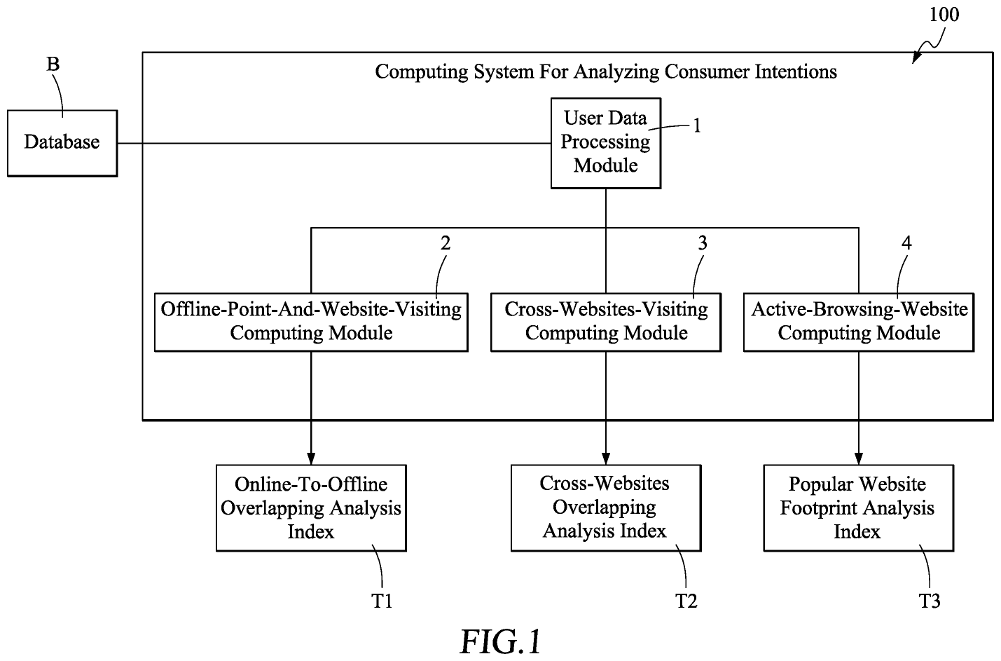

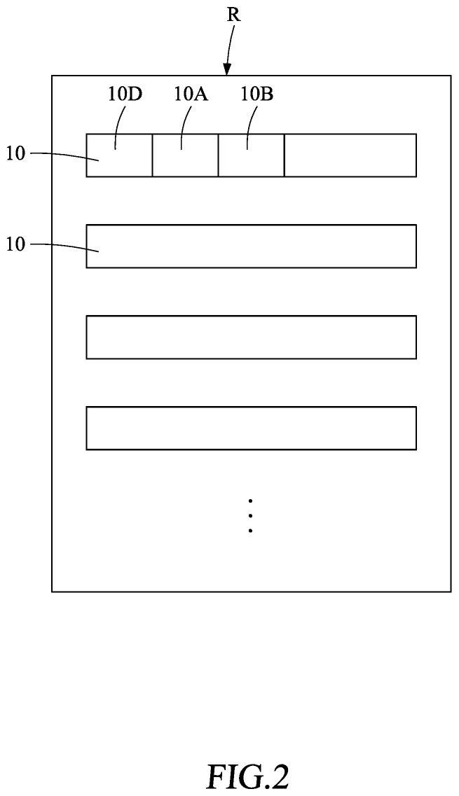

The preferred embodiments of the present invention are described in detail with reference to FIGS. 1 to 5. The description is used for explaining the embodiments of the present invention only, but not for limiting the scope of the claims.

As shown in FIG. 1, a computing system 100 for analyzing consumer intentions according to one embodiment of the present invention comprises a user data processing module 1, an offline-point-and-website-visiting computing module 2, a cross-websites-visiting computing module 3 and a active-browsing-website computing module 4. Therefore, the computing system 100 for analyzing consumer intentions of the present invention can analyze consumers' behavior characteristics, such as visiting data about consumers who have visited certain business stores' online websites and/or offline points, so as to accurately predict consumers' preferences or consumer intentions, thereby facilitating the subsequent planning in advertising and marketing.

As shown in FIGS. 1 to 3, the user data processing module 1 has a data obtaining unit 11 and a data statistical unit 12. The data obtaining unit 11 obtains raw data from a database B, wherein the raw data contains a plurality of user data Each of the user data 10 is corresponding to a consumer and contains a website visiting history 10A and/or an offline point visiting history 10B. Furthermore, the website visiting history 10A is a visiting history of online websites which the consumer has visited. The offline point visiting history 10B is a visiting history of offline points which the consumer has visited.

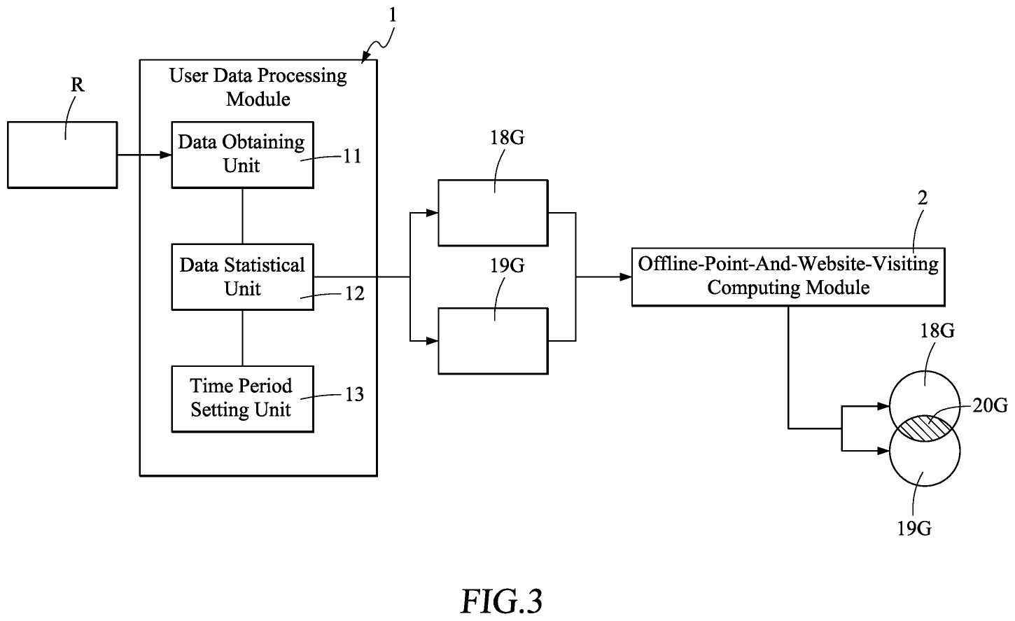

In a specific embodiment of the present invention, as shown in FIG. 3, the data statistical unit 12 sorts, from the plurality of user data 10, a website visiting data cluster 18G and an offline point visiting data cluster 19G. The website visiting data cluster 18G is a cluster of the user data 10 containing the website visiting history 10A. The offline point visiting data cluster 19G is a cluster of the user data 10 containing the offline point visiting history 10B.

Specifically, as shown in FIG. 3, according to the computing system 100 for analyzing consumer intentions of one embodiment of the present invention, the user data processing module 1 further has a time period setting unit 13 which is connected to the data statistical unit 12. The time period setting unit 13 is provided to set a data sorting time period, and the data statistical unit 12 respectively sorts, according to the data sorting time period, the website visiting data cluster 18G of the website visiting history 10A in the data sorting time period and the offline point visiting data cluster 19G of the offline point visiting history in the data sorting time period from the user data 10. For example, with the data sorting time period set by the time period setting unit 13, the data statistical unit 12 sorts the daily website visiting data cluster 18G and the daily offline point visiting data cluster 19G, which is provided to performance a data analysis of the consumer's behavior.

Specifically, as shown in FIGS. 1 to 3, according to the computing system 100 for analyzing consumer intentions of one embodiment of the present invention, the user data processing module 1 is connected to the database B so that the data obtaining unit 11 obtains the raw data R from the database B. Moreover, a real identity feature of the consumer is performed a de-identification process to obtain an individual identification code 10D corresponding to the user data 10 in the database B. In other words, the present invention performs the data processing and analyzing on the raw data R without revealing the real identity features of the consumers, in compliance with the Personal Data Protection Act. The database B can be obtained from a telecommunications data provider but not limited thereto.

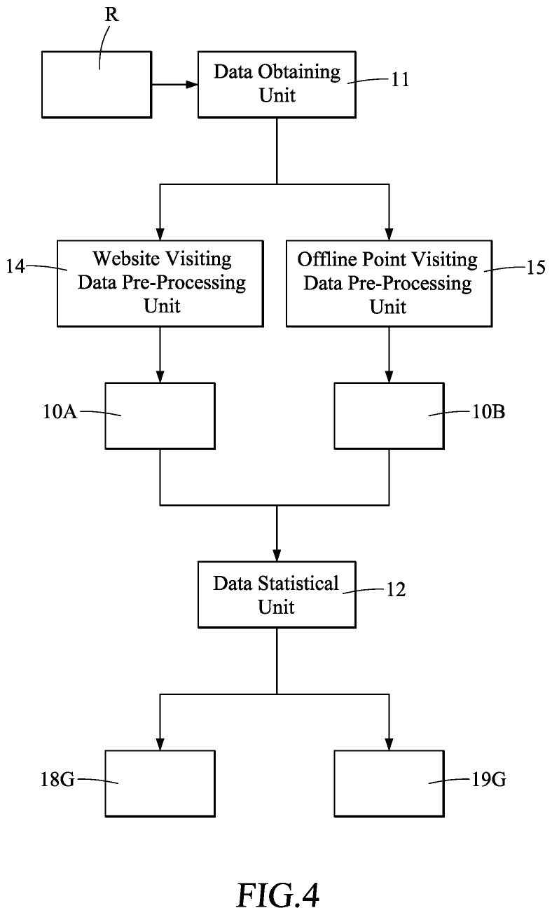

In a specific embodiment of the present invention, as shown in FIGS. 1 and 4, according to the computing system 100 for analyzing consumer intentions of one embodiment of the present invention, the user data processing module 1 contains a website visiting data pre-processing unit 14. The website visiting data pre-processing unit 14 derives, according to a domain name format, the website visiting history 10A of the user data 10 from the raw data R.

In addition, as shown in FIGS. 1 and 4, according to the computing system 100 for analyzing consumer intentions of one embodiment of the present invention, the user data processing module 1 contains an offline point visiting data pre-processing unit 15. The offline point visiting data pre-processing unit 15 derives, according to a default address format, the offline point visiting history 10B of the user data 10 from the raw data R, wherein the default address format contains Arabic numerals, commas and decimal point.

In detail, according to the computing system 100 for analyzing consumer intentions of one embodiment of the present invention, the offline point visiting history 10B of the user data 10 contains longitude and latitude data of the offline point which the consumer has visited.

As shown in FIGS. 1 and 3, the offline-point-and-website-visiting computing module 2 is connected to the user data processing module 1. The offline-point-and-website-visiting computing module 2 obtains, according to the website visiting data cluster 18G and the offline point visiting data cluster 19G, an offline-point-and-web site-dual-vi siting data cluster 20G. The offline-point-and-website-dual-visiting data cluster 20G is a cluster of the user data 10 containing both the web site visiting history 10A of any online website of a business store and the offline point visiting history 10B of any offline-point of the business store.

In detail, as shown in FIGS. 1 and 3, the offline-point-and-website-visiting computing module 2 derives, according to an overlapping proportion of the consumers corresponding to the offline-point-and-website-dual-visiting data cluster 20G to the consumers corresponding to the web site visiting data cluster 18G, offline-point-and-website-visiting overlapping proportion information of the business store which is served as an online-to-offline overlapping analysis index T1. In other words, the present invention determines the consumer's preferences or consumer intentions for the business store by a behavior characteristic that the consumer visits both the online website and the offline point of the business store, i.e., the consumer has a strong interest in commodities of the business store.

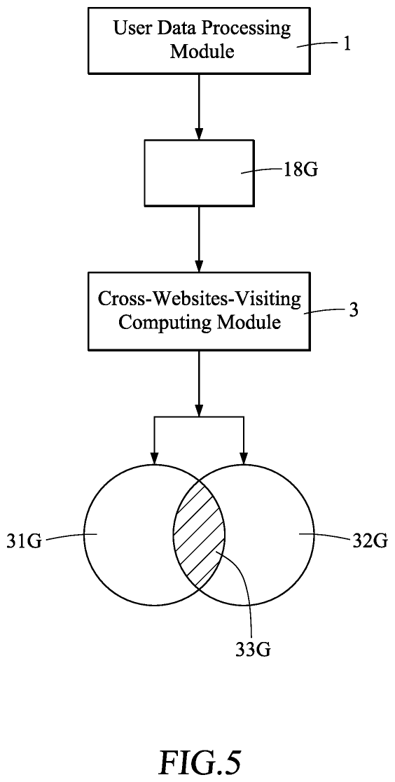

As shown in FIGS. 1 and 5, the cross-websites-visiting computing module 3 is connected to the user data processing module 1. The cross-websites-visiting computing module 3 sorts, according to the website visiting data cluster 18G, single-web site-visiting data clusters 31G relating to their respective target websites. Each of the single-website-visiting data clusters 31G is a single-target-website user data cluster containing the website visiting history of the target website.

Moreover, as shown in FIGS. 1 and 5, and the cross-websites-visiting computing module 3 further derives a cross-websites-visiting user amount (which is corresponding to the amount of cross-websites user data clusters 33G) of the consumers corresponding to the designated single-website-visiting data cluster (which is corresponding to the amount of single-target-website-and-other-target-website user data clusters 32G) who have also visited any other target website and derives a single-website-visiting user amount of the consumers corresponding to the designated single-website-visiting data cluster. Therefore, cross-websites-visiting overlapping proportion information is obtained according to a proportion of the cross-websites-visiting user amount (which is corresponding to the amount of cross-websites user data clusters 33G) to the single-website-visiting user amount (which is corresponding to the amount of all the user data clusters) and is served as a cross-websites overlapping analysis index T2. In other words, the cross-websites user data clusters 33G shows the consumers “who visit multiple online websites to obtain commodities' information for purpose of product consumption”, i.e., consumers who have active consumer intentions. Moreover, in addition to analyzing the consumers who have active consumer intentions, the cross-websites overlapping analysis index T2 can be used to analyze an overlapping proportion relationship among different brands to summarize a competitive relationship among the brands (i.e., which brands have more overlapping consumers with each other) so as to assist the brand owner to analyze competitors and consumer markets to develop marketing strategies. As shown in FIG. 1, according to the computing system 100 for analyzing consumer intentions of one embodiment of the present invention, the active-browsing-website computing module 4 is connected to the user data processing module 1. The active-browsing-web site computing module 4 derives, according to the website visiting data cluster 18G, rankings of visiting footprint amounts relating to respective comparison websites to obtain website popularity information which is served as a popular website footprint analysis index T3. Specifically, the visiting footprint amount is a total number of the consumers corresponding to the user data 10 of the website visiting history 10A relating to the comparison website. In other words, the present invention finds out which comparison websites are visited by the majority of consumers by analyzing the rankings of visiting footprint amounts relating to the respective comparison web sites so as to determine the consumers' preferences or intentions for the comparison web sites (which present commodities sales information). By analyzing the rankings of visiting footprint amounts relating to respective comparison websites, the computing system 100 not only knows the consumers' preferences and intentions for the commodities but also the consumers' interests and behaviors based on types of the websites which the consumers preferably visit, e.g., news, finance, cars and health (the reason is that the popular websites are not only the commodity websites but also other kinds of websites such as community, audio-video, news media and shopping websites that the consumers prefer to visit).

It can be known from the above, the computing system 100 for analyzing consumer intentions respectively obtains the online-to-offline overlapping analysis index T1 (which indicates that the consumers visit both the business store's online website and offline point, and means that the consumers have strong interests to the business store's commodities), the cross-websites overlapping analysis index T2 (which means that the consumers visit multiple online web sites to compare and search for the information about a specific commodity) and the popular website footprint analysis index T3 (which can show a ranking of the online websites based on the number of the consumers visit for commodity information; a ranking of the consumers groups interested in a specific commodity; and a ranking of the online websites which the consumers groups usually preferably browse also can be presented) by the user data processing module 1, the offline-point-and-website-visiting computing module 2, the cross-websites-visiting computing module 3 and the active-browsing-website computing module 4. Therefore, the present invention analyzes the consumers' behavior characteristics based on the online-to-offline overlapping analysis index T1, the cross-websites overlapping analysis index T2 and the popular website footprint analysis index T3 to accurately predict the consumers' preferences and intentions, thereby facilitating the subsequent planning in advertising and marketing.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A computing system for analyzing consumer intentions, comprising:
a user data processing module having a data obtaining unit and a data statistical unit, the data obtaining unit obtaining raw data from a database, the raw data containing a plurality of user data, each of which being corresponding to a consumer and containing a website visiting history and/or an offline point visiting history, wherein the website visiting history is a visiting history of online websites on which the consumer has visited, the offline point visiting history is a visiting history of offline points on which the consumer has visited, the data statistical unit sorts, from the plurality of user data, a website visiting data cluster and an offline point visiting data cluster, the website visiting data cluster is a cluster of the user data containing the website visiting history, the offline point visiting data cluster is a cluster of the user data containing the offline point visiting history;
an offline-point-and-website-visiting computing module being connected to the user data processing module, wherein the offline-point-and-website-visiting computing module obtains, according to the website visiting data cluster and the offline point visiting data cluster, an offline-point-and-website-dual-visiting data cluster, the offline-point-and-website-dual-visiting data cluster is a cluster of the user data containing both the website visiting history of any online website of a business store and the offline point visiting history of any offline-point of the business store, and the offline-point-and-website-visiting computing module derives, according to an overlapping proportion of the consumers corresponding to the offline-point-and-web site-dual-visiting data cluster to the consumers corresponding to the web site visiting data cluster, offline-point-and-website-visiting overlapping proportion information of the business store which is served as an online-to-offline overlapping analysis index; and
a cross-websites-visiting computing module being connected to the user data processing module, wherein the cross-websites-visiting computing module sorts, according to the website visiting data cluster, single-website-visiting data clusters relating to their respective target websites, each of the single-website-visiting data clusters is a single-target-website user data cluster containing the website visiting history of the target website, and the cross-websites-visiting computing module further derives a cross-websites-visiting user amount of the consumers corresponding to the designated single-website-visiting data cluster who have also visited any other target website and derives a single-website-visiting user amount of the consumers corresponding to the designated single-website-visiting data cluster so that cross-websites-visiting overlapping proportion information is obtained according to a proportion of the cross-websites-visiting user amount to the single-website-visiting user amount and is served as a cross-websites overlapping analysis index.

2. The computing system for analyzing consumer intentions as claimed in claim 1, wherein the user data processing module further has a time period setting unit connected to the data statistical unit, the time period setting unit is provided to set a data sorting time period, and according to the data sorting time period, the data statistical unit respectively sorts the website visiting data cluster of the website visiting history in the data sorting time period and the offline point visiting data cluster of the offline point visiting history in the data sorting time period.

3. The computing system for analyzing consumer intentions as claimed in claim 1, further comprising a active-browsing-website computing module connected to the user data processing module, wherein the active-browsing-website computing module derives, according to the website visiting data cluster, rankings of visiting footprint amounts relating to respective comparison websites to obtain website popularity information which is served as a popular website footprint analysis index, wherein the visiting footprint amount is a total number of the consumers corresponding to the user data of the website visiting history relating to the comparison website.

4. The computing system for analyzing consumer intentions as claimed in claim 1, wherein the user data processing module is connected to the database so that the data obtaining unit obtains the raw data from the database, and a real identity feature of the consumer is performed a de-identification process to obtain an individual identification code corresponding to the user data in the database.

5. The computing system for analyzing consumer intentions as claimed in claim 1, wherein the user data processing module contains a website visiting data pre-processing unit, the website visiting data pre-processing unit derives, according to a domain name format, the web site visiting history of the user data from the raw data.

6. The computing system for analyzing consumer intentions as claimed in claim 1, wherein the user data processing module contains an offline point visiting data pre-processing unit, the offline point visiting data pre-processing unit derives, according to a default address format, the offline point visiting history of the user data from the raw data, the default address format contains Arabic numerals, commas and decimal point.

7. The computing system for analyzing consumer intentions as claimed in claim 1, wherein the offline point visiting history of the user data contains longitude and latitude data of the offline point which the consumer has visited.
